(19) United States
(12) Patent Application Publication
(10) Pub. No.: US 2026/0290660 A1
(43) Pub. Date: Sep. 24, 2026

(54) THICK FILM RESISTOR

(71) Applicant: SUMITOMO METAL MINING CO., LTD., Tokyo (JP)

(72) Inventor: Katsuhiro KAWAKUBO, Tokyo (JP)

(21) Appl. No.: 19/475,625

(22) PCT Filed: Apr. 23, 2024
(86) PCT No.: PCT/JP2024/015884

§ 371 Date: Oct. 15, 2025

(30) Foreign Application Priority Data
Apr. 28, 2023 (JP) 2023-075114

(51) Int. Cl. H01C 7/00; H01C 17/065

(52) U.S. Cl. CPC H01C 7/003; H01C 17/06533; H01C 17/06553

(57) ABSTRACT

A thick film resistor includes ruthenium oxide and glass. The ruthenium oxide has a rutile type crystal structure. The ruthenium oxide satisfies Lc/La of 0.6885 or greater, when an a-axis lattice constant and a c-axis lattice constant of the ruthenium oxide as measured by X-ray diffraction are determined as La and Lc, respectively. The ruthenium oxide has a crystallite size of 10 nm or greater and 80 nm or less.

### TECHNICAL FIELD

The present invention relates to thick film resistors.

### BACKGROUND OF THE INVENTION

As resistors, such as chip resistors, hybrid ICs, resistor networks, or the like, thick film resistors are typically used. A thick film resistor is formed by applying a thick film resistor paste onto a ceramic substrate and firing the paste.

As a thick film resistor composition, a composition including, as main constituent components, a ruthenium-based conductive powder, such as a ruthenium oxide powder serving as conductive particles, and a glass powder is commonly used.

Reasons why the ruthenium-based conductive powder and the glass powder are used for a thick film resistor are because the ruthenium-based conductive powder and the glass powder can be fired in air, a temperature coefficient of resistance (TCR) can be brought close to 0, and a resistor having a wide range of resistance values can be formed.

When the thick film resistor composition, which includes the ruthenium-based conductive powder and the glass powder, is used, the blending ratio between the ruthenium-based conductive powder and the glass powder affects the resistance value of a resultant thick film resistor.

Specifically, if the blending ratio of the ruthenium-based conductive powder increases, the resistance value of the thick film resistor decreases, and if the blending ratio of the ruthenium-based conductive powder decreases, the resistance value of the thick film resistor increases. By utilizing the above characteristics, the blending ratio between the ruthenium-based conductive powder and the glass powder is adjusted in the thick film resistor to achieve a desired resistance value.

In recent years, the number of resistors mounted in electric and electronic devices has increased. Thus, it is desired that each resistor has a high precision of a resistance value and has a temperature coefficient of resistance (TCR) of close to 0.

As described above, when a low resistance value is desired, a large amount of the ruthenium-based conductive powder and a small amount of the glass powder are blended in the thick film resistor composition that includes the ruthenium-based conductive powder and the glass powder. When a high resistance value is desired, the resistance value is adjusted by blending a small amount of the ruthenium-based conductive powder and a large amount of the glass powder. However, the temperature coefficient of

resistance (TCR) is likely to be plus in a region of a low resistance value region achieved by blending a large amount of the ruthenium-based conductive powder, and the temperature coefficient of resistance (TCR) is likely to be minus in a region of a high resistance value achieved by blending a small amount of the ruthenium-based conductive powder. The temperature coefficient of resistance (TCR) indicates a change of a resistance value corresponding to a temperature change, and is one of important characteristics of the thick film resistor. The temperature coefficient of resistance can be adjusted mainly by adding a metal oxide, which is referred to as a modifier, to the composition. It is relatively easy to adjust the temperature coefficient of resistance to become minus. Examples of the modifier used include manganese oxide, niobium oxide, tantalum oxide, titanium oxide, and the like. However, it is difficult to adjust the temperature coefficient of resistance to become plus. Therefore, conductive particles for a thick film resistor are desirably conductive particles which can adjust the temperature coefficient of resistance to be close to 0 or to become plus, when the conductive particles are used for a thick film resistor.

A temperature coefficient of resistance (TCR) of a thick film resistor is evaluated by a cold temperature coefficient of resistance (COLD-TCR) on a low temperature side, and a hot temperature coefficient of resistance (HOT-TCR) on a high temperature side relative to an ambient temperature as a reference.

In recent years, there has been an increasing demand for higher precision of electric components, and therefore both a cold temperature coefficient of resistance (COLD-TCR) and a hot temperature coefficient of resistance (HOT-TCR) are desired to be close to 0.

In the case of a thick film resistor produced using a thick film resistor composition, which includes a ruthenium-based conductive powder and a glass powder, it is generally difficult to make a cold temperature coefficient of resistance (COLD-TCR) on a low temperature side and a hot temperature coefficient of resistance (HOT-TCR) on a high temperature side the same. Moreover, it is difficult to bring both the cold temperature coefficient of resistance (COLD-TCR) and the hot temperature coefficient of resistance (HOT-TCR) close to 0.

Patent Document 1 discloses a resistor paste including a glass composition substantially free from at least lead, a conductive material substantially free from lead, and an organic vehicle mixed with the glass composition and the conductive material, where an average particle size of the conductive material is 5 μm or greater and 50 μm or less. Moreover, Patent Document 1 discloses a thick film resistor formed by applying the resistor paste by coating or printing, and then firing the resistor paste.

According to Patent Document 1, since the average particle size of the conductive material is 5 μm or greater and 50 μm or less, while achieving a high resistance value of 10 kΩ/square or greater, it is possible to achieve a small variation of resistance values, a small absolute value of temperature characteristics (TCR), and good voltage resistance characteristics (short term overload (STOL)).

### RELATED-ART DOCUMENT

### Patent Document

Patent Document 1: Japanese Patent Application Laid-Open No. 2005-129806
Patent Document 2: Japanese Patent Application Laid-Open No. 2005-209742

### SUMMARY OF THE INVENTION

### Problems to be Solved by the Invention

In recent years, there is a demand for a thick film resistor, which can bring both a cold temperature coefficient of resistance (COLD-TCR) on a low temperature side and a hot temperature coefficient of resistance (HOT-TCR) on a high temperature side close to 0, and can reduce a difference between the cold temperature coefficient of resistance and the hot temperature coefficient of resistance. However, in Patent Document 1, a cold temperature coefficient of resistance on a low temperature side, or a difference between a cold temperature coefficient of resistance and a hot temperature coefficient of resistance is not evaluated.

Considering the above-described problems existing in the related art, an object of one aspect of the present invention is to provide a thick film resistor that can bring a temperature coefficient of resistance close to 0, and can reduce a difference between a cold temperature coefficient of resistance and a hot temperature coefficient of resistance.

### Means for Solving the Problems

According to the present invention for solving the above problems, there is provided a thick film resistor that includes ruthenium oxide and glass. In the thick film resistor, the ruthenium oxide has a rutile type crystal structure; the ruthenium oxide satisfies Lc/La of 0.6885 or greater, when an a-axis lattice constant and a c-axis lattice constant of the ruthenium oxide as measured by X-ray diffraction are determined as La and Lc, respectively; and the ruthenium oxide has a crystallite size of 10 nm or greater and 80 nm or less.

### Effects of the Invention

According to one aspect of the present invention, there is provided a thick film resistor that can bring a temperature coefficient of resistance close to 0, and can reduce a difference between a cold temperature coefficient of resistance and a hot temperature coefficient of resistance.

### BRIEF DESCRIPTION OF THE DRAWING

FIG. 1 is an explanatory diagram depicting a relationship between the a-axis lattice constant and c-axis lattice constant of ruthenium oxide powders used in Examples and Comparative Examples.

### DETAILED DESCRIPTION OF THE INVENTION

### [Thick Film Resistor]

One embodiment of the thick film resistor of the present invention will be described hereinafter.

The inventors of the present invention have studied a thick film resistor that can bring a temperature coefficient of resistance close to 0, and can reduce a difference between a cold temperature coefficient of resistance and a hot temperature coefficient of resistance. As a result, the inventors have found that a

temperature coefficient of resistance (TCR) of the thick film resistor can be brought close to 0 by setting a ratio between an a-axis lattice constant and a c-axis lattice constant of ruthenium oxide constituting the thick film resistor to a predetermined value or greater. Specifically, the inventors have found that the cold temperature coefficient of resistance and the hot temperature coefficient of resistance of the thick film resistor can be brought close to 0, and a difference between the cold temperature coefficient of resistance and the hot temperature coefficient of resistance can be reduced.

Further, the inventors have found that a thick film resistor having a small variation in a resistance value and having good electrical characteristics can be formed by setting a crystallite size of the ruthenium oxide constituting the thick film resistor in a predetermined range.

Based on the above findings, the present invention has been completed. Hereinafter, the thick film resistor of the present embodiment will be described.

Transition of constituent components of a thick film resistor composition during the formation process of a thick film resistor from the thick film resistor composition will be discussed. The thick film resistor composition includes a glass powder and a ruthenium-based conductive powder. In the thick film resistor composition before firing, ruthenium-based conductive particles constituting the ruthenium-based conductive powder are present in the surrounding area of glass particles constituting the glass powder. The glass particles are fused to one another by heat applied during firing so that the ruthenium-based particles are brought close to one another to form a conductive path. The resultant thick film resistor includes the conductive path formed of the ruthenium-based conductor derived from the ruthenium-based conductive particles, and glass as a matrix that holds the conductive path. Specifically, the constituent components of the thick film resistor include the ruthenium-based conductor and the glass. In the thick film resistor of the present embodiment, ruthenium oxide is used as the ruthenium-based conductor. Accordingly, the thick film resistor of the present embodiment includes ruthenium oxide and glass.

### (1) Components Included in Thick Film Resistor

The components included in the thick film resistor of the present embodiment will be described.

### (1-1) Ruthenium Oxide

(Ratio of c-Axis Lattice Constant Lc to a-Axis Lattice Constant La)

The inventors of the preset invention have found that the lattice constant of the ruthenium oxide affects properties of a thick film resistor including ruthenium oxide and glass, and therefore have completed the present invention based on this insight.

According to the study conducted by the inventors of the present invention, the ruthenium oxide preferably has a rutile type crystal structure. In addition, when an a-axis lattice constant of the ruthenium oxide, and a c-axis lattice constant of the ruthenium oxide as measured by X-ray diffraction are determined as La and Lc, respectively, a ratio (Lc/La) of the c-axis lattice constant Lc of the ruthenium oxide to the a-axis lattice constant La of the ruthenium oxide is important for controlling a temperature coefficient of resistance of a resultant thick film resistor. Specifically, the temperature coefficient of resistance (TCR) of the thick film resistor can be brought close to 0 by setting Lc/La of the ruthenium oxide to 0.6885 or greater, and more preferably 0.6886 or greater.

For example, a bulk state of ruthenium oxide having a rutile type crystal structure, which is a tetragonal crystal, and having a sufficiently large crystal size has an a-axis lattice constant of 4.499 Å, and a c-axis lattice constant of 3.107 Å. Note that Lc/La of the c-axis lattice constant Lc of the ruthenium oxide bulk to the a-axis lattice constant La of the ruthenium oxide bulk is 0.6906. The lattice constants of the bulk state of the ruthenium oxide are acquired from the International Centre for Diffraction Data.

Conversely, the lattice constants of the ruthenium oxide in the thick film resistor of the present invention including the ruthenium oxide and glass are smaller than the lattice constants of ruthenium oxide of the bulk state, in terms of the a-axis, the c-axis, and Lc/La. This is likely to be because the ruthenium oxide in the thick film resistor is composed of fine ruthenium oxide particles.

According to the study conducted by the inventors of the present invention, a cold temperature coefficient of resistance (COLD-TCR) and a hot temperature coefficient of resistance (HOT-TCR) are significantly different in a thick film resistor that includes ruthenium oxide satisfying Lc/La of less than 0.6885. Therefore, the thick film resistor that includes the ruthenium oxide satisfying Lc/La of less than 0.6885 cannot reduce a difference between a cold temperature coefficient of resistance (COLD-TCR) and a hot temperature coefficient of resistance (HOT-TCR), and cannot bring both the cold temperature coefficient of resistance (COLD-TCR) and the hot temperature coefficient of resistance (HOT-TCR) close to 0.

The upper limit of Lc/La, which is a ratio of a c-axis lattice constant Lc of the ruthenium oxide in the thickness film resistor of the present embodiment to an a-axis lattice constant La of the ruthenium oxide in the thickness film resistor, is not particularly limited. Lc/La may be 0.690 or less, for example, when the crystallite size is 10 nm or greater and 80 nm or less.

The ratio Lc/La of the c-axis lattice constant to the a-axis lattice constant increases as the c-axis lattice constant increases and the a-axis lattice constant decreases. According to the study conducted by the inventors of the present invention, a clear correlation between the a-axis lattice constant and the c-axis lattice constant of the ruthenium oxide cannot be observed. Thus, the above Lc/La cannot be controlled, for example, by controlling only an a-axis lattice constant or a c-axis lattice constant.

Patent Document 2 has brought attention to an a-axis and b-axis of ruthenium oxide and discloses that the a-axis and the b-axis are set within predetermined ranges. According to the study conducted by the inventors of the present invention, however, a cold temperature coefficient of resistance (COLD-TCR) and a hot temperature coefficient of resistance (HOT-TCR) of a thick film resistor including a ruthenium oxide powder cannot be brought close to 0 only by setting the a-axis lattice constant and the b-axis lattice constant of the ruthenium oxide powder in the predetermined ranges. In addition, a difference between the hot temperature coefficient of resistance and the cold temperature coefficient of resistance cannot be reduced by setting the a-axis lattice constant and the b-axis lattice constant of the ruthenium oxide powder in the predetermined ranges.

Accordingly, in the case of a thick film resistor, it is important to set Lc/La to a predetermined value or greater in order to bring the cold temperature coefficient of resistance (COLD-TCR) and the hot temperature coefficient of resistance (HOT-TCR) close to 0, and reduce the difference between the hot temperature coefficient of resistance and the cold temperature coefficient of resistance.

### (Crystallite Size)

By setting the crystallite size of the ruthenium oxide included in the thick film resistor of the present embodiment to 10 nm or greater and 80 nm or less (100 Å or greater and 800 Å or less), a precision of a resistance value of a thick film resistor can be improved. Specifically, a variation in resistance values can be minimized. Moreover, by using the ruthenium oxide having the crystallite size and the lattice constant ratio Lc/La within the predetermined ranges, the difference between the cold temperature coefficient of resistance and hot temperature coefficient of resistance of the thick film resistor can be reduced, and in particular, both the cold temperature coefficient of resistance and hot temperature coefficient of resistance of the thick film resistor can be brought close to 0. Further, as the ruthenium oxide satisfies the range of the crystallite size, a thick film resistor having good electrical characteristics can be formed.

In order to adjust Lc/La of the ruthenium oxide included in the thick film resistor to 0.6885 or greater, Lc/La of a ruthenium oxide powder as a raw material of a thick film resistor composition or resistor paste for forming a thick film resistor can be adjusted. According to the study conducted by the inventors of the present invention, a thick film resistor satisfying Lc/La≥0.6885 can be formed by printing, drying, and firing a resistor paste or the like including a ruthenium oxide powder satisfying Lc/La≥0.6913.

There is almost no difference in the lattice constants and crystallite size of ruthenium oxide between the ruthenium oxide in a state in which the ruthenium oxide is included in a resistor paste that is printed and dried at 150° C. or lower, and the ruthenium oxide in the state of the ruthenium oxide powder used as a raw material of the resistor paste. This suggests that the lattice constants and crystallite size of the ruthenium oxide powder hardly change in a step of dispersing or kneading the ruthenium oxide powder and the glass powder in an organic vehicle. However, the lattice constants and crystallite size of ruthenium oxide measured on the thick film resistor formed by firing the dried resistor paste at a temperature of 800° C. or higher are different from the lattice constants and crystallite size of the ruthenium oxide measured on the dried resistor paste. Specifically, the a-axis lattice constant La and crystallite size of the ruthenium oxide increase, and the c-axis lattice constant Lc of the ruthenium oxide decreases. Therefore, Lc/La decreases and the crystallite size increases as the resistor paste is fired.

The lattice constants and crystallite size of the ruthenium oxide can be determined by analyzing a diffraction pattern obtained by powder X-ray diffraction. In recent years, it has become possible to accurately measure and calculate lattice constants and a crystallite size of a powder by Rietveld refinement of powder X-ray diffraction.

### (1-2) Glass

Regardless of a composition or the like of glass, the thick film resistor of the present embodiment can bring a temperature coefficient of resistance close to 0, and can reduce a difference between a cold temperature coefficient of resistance and a hot temperature coefficient of resistance. Specifically, even if lead-containing glass that has been used in the related art, or lead-free glass that reduces adverse effects to human bodies and pollution is used in the thickness film resistor of the present embodiment, the thick film resistor can bring a temperature coefficient of resistance close to 0, and can attain a temperature coefficient of resistance with high precision. In addition, the thick film resistor can reduce a difference between a cold temperature coefficient of resistance and a hot temperature coefficient of resistance.

Lead-containing glass, which has been typically used for thick film resistors, can be used, but use of lead-free glass has been desired in recent years in view of concerns about the environmental issues.

In the case where the thick film resistor of the present embodiment includes lead-free glass as the glass, the lead-free glass preferably includes, for example, SiO₂, B₂O₃, and RO (R is at least one alkaline earth metal element selected from the group consisting of Ca, Sr, and Ba). In this case, when a total of SiO₂, B₂O₃, and RO is determined as 100 parts by mass, SiO₂ is preferably included in the amount of 18 parts by mass or greater and 50 parts by mass or less, B₂O₃ is preferably included in the amount of 10 parts by mass or greater and 30 parts by mass or less, and RO is preferably included in the amount of 35 parts by mass or greater and 70 parts by mass or less.

Since the thick film resistor includes the glass, a temperature coefficient of resistance is particularly easily brought close to 0.

The glass included in the thick film resistor of the present embodiment is derived from a glass powder used in a thick film resistor composition or the like. Thus, a reason behind a suitable range of each component constituting the glass is the same as described in association with the glass powder of the thick film resistor composition, and therefore redundant description will be omitted.

In the case where the glass included in the thick film resistor is lead-free glass, the glass preferably includes SiO₂, B₂O₃, and RO as essential components. The glass may be composed of SiO₂, B₂O₃, and RO. Alternatively, the glass may further include other components. Examples of other components in the glass include Al₂O₃, ZrO₂, TiO₂, SnO₂, ZnO, Li₂O, Na₂O, K₂O, and the like. Al₂O₃ can inhibit phase separation. ZrO₂ and TiO₂ have a function of improving weather resistance of glass. SnO₂, ZnO, Li₂O, Na₂O, K₂O, and the like have a function of increasing fluidity of glass.

### (2) Ratio Between Ruthenium Oxide Content and Glass Content

A blending ratio between the ruthenium oxide and the glass in the thick film resistor can be varied depending on a desired resistance value or the like, and therefore a mass ratio between the ruthenium oxide and the glass in the thick film resistor of the present embodiment is not particularly limited.

However, in the thick film resistor of the present embodiment, the mass ratio is preferably in the range of the mass of ruthenium oxide: the mass of glass=60:40 to 5:95. Specifically, when a total mass of the ruthenium oxide and the glass included in the thick film resistor is determined as 100%, the mass ratio of the ruthenium oxide based on the percentage is preferably 5% or greater and 60% or less.

By setting the mass ratio of the ruthenium oxide to 60% or less when the total mass of the ruthenium oxide and the glass is determined as 100%, the thick film resistor is prevented from becoming brittle, and formation of cracks or the like can be inhibited.

By setting the mass ratio of the ruthenium oxide to 5% or greater when the total mass of the ruthenium oxide and the glass is determined as 100%, the resistance value of the thick film resistor is inhibited from becoming significantly high, and stability of the thick film resistor can be enhanced.

The thick film resistor of the present embodiment can also include various additives in addition to the ruthenium oxide and the glass. Specifically, the thick film resistor of the present embodiment can include the ruthenium oxide, the glass, and additives. The additives will be described through the description of the thick film resistor composition.

The thick film resistor of the present embodiment may be composed of the ruthenium oxide and the glass. In addition, the thick film resistor may be composed of the ruthenium oxide, the glass, and the additives. In either case, the thick film resistor may include inevitable impurities.

### (3) Characteristics of Thick Film Resistor

The thick film resistor of the present embodiment can bring both a cold temperature coefficient of resistance and a hot temperature coefficient of resistance close to 0, and can reduce a difference between the cold temperature coefficient of resistance and the hot temperature coefficient of resistance. The temperature coefficient of resistance of the thick film resistor of the present disclosure is preferably −50 ppm/° C. or greater and +50 ppm/° C. or less, more preferably −40 ppm/° C. or greater and +40 ppm/C or less, and yet more preferably −30 ppm/C or greater and +30 ppm/° C. or less. Note that the above ranges are preferred ranges for both the hot temperature coefficient of resistance and the cold temperature coefficient of resistance.

Moreover, the difference between the hot temperature coefficient of resistance and the cold temperature coefficient of resistance of the thick film resistor is preferably 70 ppm/° C. or less, and more preferably 60 ppm/° C. or less. As demonstrated in the below-described Examples, the cold temperature coefficient of resistance and hot temperature coefficient of resistance of the thick film resistor of the present embodiment can be set in the above range, and for example, can be-30 ppm/° C. or greater and +30 ppm/° C. or less. Further, the difference between the hot temperature coefficient of resistance and the cold temperature coefficient of resistance of the thick film resistor can be reduced.

Further, the thick film resistor of the present embodiment can realize a temperature coefficient of resistance and a resistance value with high precision, and can achieve excellent characteristics in current noise, a short term overload (STOL) test, and the like.

The COLD-TCR, which is the cold temperature coefficient of resistance, can be calculated by the following equation (1).

The HOT-TCR, which is the hot temperature coefficient of resistance, can be calculated by the following equation (2).

$$COLD - TCR ( ppm / ° C . ) = ( {R}_{- 55} - {R}_{25} ) / {R}_{25} / ( - 80 ) \times {10}^{6} \qquad ( 1 )$$

$$HOT - TCR ( ppm / ° C . ) = ( {R}_{125} - {R}_{25} ) / {R}_{25} / ( 100 ) \times {10}^{6} \qquad ( 2 )$$

In the equations above, R₋₅₅ is a resistance value at a temperature of −55° C., R₂₅ is a resistance value at a temperature of 25° C., and R₁₂₅ is a resistance value at a temperature of 125° C.

According to the thick film resistor of the present embodiment, the temperature coefficient of resistance, the resistance value precision, and excellent characteristics in current noise and a short term overload test can be achieved as described above.

### [Thick Film Resistor Composition]

Next, a configuration example of the thick film resistor composition of the present embodiment will be described.

The above-described thick film resistor can be produced by using a thick film resistor composition. The thick film resistor composition includes a ruthenium oxide powder serving as conductive particles, and a glass powder.

The components included in the thick film resistor composition, which can be suitably used when the thick film resistor of the present embodiment is produced, will be described.

### (1) Ruthenium Oxide Powder

As described above, the ruthenium oxide powder has a rutile type crystal structure, satisfies a ratio Lc/La of 0.6913 or greater where La is an a-axis lattice constant and Lc is a c-axis lattice constant as measured by X-ray diffraction, and has a crystallite size of 10 nm or greater and 80 nm or less.

A particle size of the ruthenium oxide powder is not particularly limited. For example, a specific surface area diameter of the ruthenium oxide powder included in the thick film resistor composition of the present embodiment is preferably 10 nm or greater and 115 nm or less.

The specific surface area diameter of the ruthenium oxide powder can be calculated from the specific surface area. Specifically, the relational expression represented by the following equation (3) is satisfied when a particle size, which is a specific surface area diameter, of the ruthenium oxide powder, is determined as D (nm), a density is determined as ρ (g/cm³), a specific surface area is determined as S (m²/g), and particles included in the ruthenium oxide powder are determined as spheres.

$$D ( nm ) = 6 \times {10}^{3} / ( ρ \cdot S ) \qquad ( 3 )$$

In the present embodiment, the particle size, which is the specific surface area diameter, can be calculated according to the equation (3) in which the density p of the ruthenium oxide is determined as 7.05 g/cm³.

### (2) Glass Powder

The glass powder is not particularly limited. As the glass powder, a glass powder that has been used for a thick film resistor composition can be used.

### Configuration Example of Composition of Glass Powder

The glass powder that can be used in the thick film resistor composition of the present embodiment is, for example, at least one selected from the group consisting of aluminoborosilicate glass, lead-free zinc borosilicate glass, lead-free calcium borosilicate glass, and lead-free barium borosilicate glass.

The glass can be typically produced by mixing predetermined components or precursors of the components according to an intended composition, melting the obtained mixture, and rapidly cooling the mixture. The melting temperature is not particularly limited, but the melting is performed, for example, at approximately 1,400° C. Further, rapid cooling can be often performed by immersing the melted mixture in cold water or pouring the melted mixture onto a cold belt. In order to prepare a raw material paste for forming a thick film resistor, the glass is pulverized. The pulverization of the glass is performed by a ball mill, a vibration mill, a planetary mill, a bead mill, or the like, until a desired particle size is obtained.

A composition of a lead-containing glass powder, which has been generally used for a thick film resistor composition, can be used. In recent years, it is however desired to use a composition of a lead-free glass powder in view of concerns about environmental issues.

In the composition of the lead-free glass powder, which is included in the thick film resistor composition, a metal oxide other than SiO₂ forming a skeleton is blended to adjust fluidity during firing. As the metal oxide other than SiO₂, B₂O₃, RO (R is at least one alkaline earth metal element selected from the group consisting of Ca, Sr, and Ba), or the like is used. Therefore, the glass powder used in the thick film resistor composition of the present embodiment preferably includes SiO₂, B₂O₃, and RO. When a total amount of SiO₂, B₂O₃, and RO in the glass composition is determined as 100 parts by mass, the glass powder preferably includes SiO₂ in the amount of 18 parts by mass or greater and 50 parts by mass or less, B₂O₃ in the amount of 10 parts by mass or greater and 30 parts by mass or less, and RO in the amount of 35 parts by mass or greater and 70 parts by mass or less. By using the above glass powder, a temperature coefficient of resistance of the obtained thick film resistor can be particularly readily brought close to 0.

Since SiO₂ is included in the amount of 18 parts by mass or greater, when a total amount of SiO₂, B₂O₃, and RO in the glass composition of the glass powder is determined as 100 parts by mass, the glass can be easily formed and the weather resistance can be enhanced. Since SiO₂ is included in the amount of 50 parts by mass or less, moreover, the softening temperature of the glass powder is inhibited from becoming high, and the fluidity can be increased.

Since the glass composition of the glass powder includes B₂O₃ in the amount of 10 parts by mass or greater, the softening temperature of the glass powder is inhibited from becoming high, and the fluidity can be increased. Since B₂O₃ is included in the amount of 30 parts by mass or less, moreover, the weather resistance can be enhanced.

Since the glass composition of the glass powder includes RO in the amount of 35 parts by mass or greater, the softening temperature of the glass is inhibited from becoming high, and the fluidity can be increased. Since RO is included in the amount of 70 parts by mass or less, moreover, crystallization is inhibited, and therefore glass is easily formed.

The lead-free glass powder used for the thick film resistor composition preferably includes the above-described SiO₂, B₂O₃, and RO as essential components. The glass powder can be composed only of SiO₂, B₂O₃, and RO, but may include other components for the purpose of adjusting weather resistance of the glass powder or fluidity during firing. Examples of the other components include Al₂O₃, ZrO₂, TiO₂, SnO₂, ZnO, Li₂O, Na₂O, K₂O, and the like. Al₂O₃ has a function of inhibiting phase separation of glass, ZrO₂ and TiO₂ have a function of improving weather resistance of glass, and SnO₂, ZnO, Li₂O, Na₂O, K₂O, and the like have a function of enhancing fluidity of glass.

### (Softening Point)

A softening point is used as a parameter that affects fluidity of glass when the thick film resistor composition is fired.

A temperature of firing the thick film resistor composition or the thick film resistor paste in production of a thick film resistor is typically 800° C. or higher and 900° C. or lower.

In the case where the firing temperature of the thick film resistor composition or the like in production of a thick film resistor is 800° C. or higher and 900° C. or lower as described above, a softening point of the glass used for the thick film resistor composition according to the present embodiment is preferably 600° C. or higher and 800° C. or lower, and more preferably 600° C. or higher and 750° C. or lower.

In the present specification, the softening point is a temperature of a peak of a differential thermal curve obtained by heating the glass at the heating rate of 10° C./min in an ambient atmosphere by differential thermal analysis (TG-DTA), where the peak is present on a high temperature side relative to the lowest temperature at which the differential thermal curve starts to decrease, and is a subsequent peak at which the differential thermal curve starts to decrease.

### (Particle Size)

A particle size of the glass powder used for a thick film resistor paste is not particularly limited, but an excessively large particle size can cause an increase in a resistance value of a thick film resistor or reduction in load characteristics. To avoid the above problems, a 50% volume cumulative particle size of the glass powder is ideally 5 μm or less, more ideally 3 μm or less, and yet more ideally 1.5 μm or less. For the pulverization of the glass, a ball mill, a planetary mill, a bead mill, or the like can be used. Wet pulverization is desirable for achieving a sharp particle size distribution.

When the particle size of the glass powder is excessively small, productivity becomes low, and an amount of impurities or the like included may increase. Therefore, the 50% volume cumulative particle size of the glass powder is preferably 0.5 μm or greater.

The 50% volume cumulative particle size is a particle size at 50% of a cumulative volume distribution measured by a laser diffraction/scattering method.

### (3) Blending Ratio Between Ruthenium Oxide Powder and Glass Powder

A blending ratio between the ruthenium oxide powder and the glass powder included in the thick film resistor composition can be varied depending on a desired resistance value or the like, and therefore the blending mass ratio between the ruthenium oxide powder and the glass powder included in the thick film resistor composition of the present embodiment is not particularly limited.

However, a ratio of a mass of the ruthenium oxide powder to a mass of the glass powder in the thick film resistor composition of the present embodiment is preferably in the range of 60:40 to 5:95. Specifically, when a total mass of the ruthenium oxide powder to be included and the glass powder to be included is determined as 100%, a mass ratio of the ruthenium oxide powder based on the percentage is preferably 5% or greater and 60% or less. The blending ratio between the ruthenium oxide powder and the glass powder in the thick film resistor composition is maintained during the formation of the thick film resistor so that the blending ratio conforms to a composition ratio between the ruthenium oxide and the glass in the thick film resistor.

When the mass ratio of the ruthenium oxide powder relative to 100% of the total mass of the ruthenium oxide powder and the glass powder is 60% or less, brittleness of the fired film can be inhibited, and formation of cracks or the like can be avoided.

Since the mass ratio of the ruthenium oxide powder relative to 100% of the total mass of the ruthenium oxide powder and the glass powder is 5% or greater, a resistance value of a thick film resistor can be inhibited from becoming excessively high, and therefore stability is increased.

### (4) Additives

The thick film resistor composition of the present embodiment can be composed of the above-described ruthenium oxide powder and glass powder, but the thick film resistor composition can further include additives. Specifically, the thick film resistor composition of the present embodiment can include a ruthenium oxide powder, a glass powder, and additives. The thick film resistor composition of the present embodiment can be composed of the ruthenium oxide powder, the glass powder, and the additives. Even in this case, the thick film resistor composition may include inevitable impurities.

In the case where a thick film resistor having a lower resistance value is desired, the thick film resistor of the present embodiment can include Ag or Pd.

In the case where a thick film resistor whose resistance value is reduced is produced by using the thick film resistor composition of the present embodiment including the above-described ruthenium oxide powder, glass powder, Ag, and Pd, both the cold temperature coefficient of resistance, and the hot temperature coefficient of resistance can be brought close to 0.

The thick film resistor composition of the present embodiment may include additives that are typically used for improving or adjusting a resistance value, a temperature coefficient of resistance, voltage load characteristics, and trimming properties of thick film resistors.

Examples of the typical additives include at least one powder selected from the group consisting of Nb₂O₅, Ta₂O₅, TiO₂, MnO₂, CuO, ZrO₂, Al₂O₃, SiO₂, ZrSiO₄, and the like.

Nb₂O₅, Ta₂O₅, TiO₂, and MnO₂ have an effect of reducing a variation in a resistance value when a voltage load is applied to a thick film resistor, but Nb₂O₅, Ta₂O₅, TiO₂, and MnO₂ shift the temperature coefficient of resistance to the minus side. CuO has an effect of reducing a resistance value of a thick film resistor to shift a temperature coefficient of resistance to the plus side. ZrO₂, Al₂O₃, SiO₂, and ZrSiO₄ have an effect of inhibiting extension of microcracks, which are likely to be formed by laser trimming performed for adjusting a resistance value of a thick film resistor.

Since the thick film resistor composition of the present embodiment includes the above additives, a thick film resistor having further improved characteristics can be produced. In the case where the thick film resistor composition of the present embodiment includes the additives, the thick film resistor produced by using the thick film resistor composition also includes the corresponding additives.

An amount of the above additives in the thick film resistor composition of the present embodiment is adjusted according to the intended purpose. When a total amount of the ruthenium oxide powder and the glass powder is determined as 100 parts by mass, for example, the additives are preferably added in the amount of greater than 0 parts by mass and 20 parts by mass or lower. The additives are preferably included in the same amount range in the thick film resistor.

### [Thick Film Resistor Paste]

Next, a thick film resistor paste, which is used for forming the thick film resistor of the present embodiment, will be described.

The thick film resistor paste, which is used for forming the thick film resistor of the present embodiment, can include a ruthenium oxide powder, a glass powder, and an organic vehicle. The thick film resistor paste of the present embodiment can be composed of the ruthenium oxide powder, the glass powder, and the organic vehicle. Even in this case, the thick film resistor paste may include inevitable impurities.

The ruthenium oxide powder and the glass powder can be both mixed and dispersed in the organic vehicle to form a thick film resistor paste for printing.

Note that the thick film resistor paste of the present embodiment may further include the additives described in association with the thick film resistor composition. In this case, the ruthenium oxide powder, the glass powder, and the additives, which are included in the thick film resistor paste of the present embodiment, are all preferably mixed and dispersed in the organic vehicle to form a thick film resistor paste for printing.

The thick film resistor paste of the present embodiment can be composed of the ruthenium oxide powder, the glass powder, the additives, and the organic vehicle. Even in this case, the thick film resistor paste may include inevitable impurities.

Each of components included in the thick film resistor paste, which is used for forming the thick film resistor of the present embodiment, will be described hereinafter.

### (1) Components Included in Thick Film Resistor Paste

### (1-1) Ruthenium Oxide Powder

As the ruthenium oxide powder, the ruthenium oxide powder described in association with the thick film resistor composition can be used. Specifically, the ruthenium oxide powder included in the thick film resistor paste of the present embodiment preferably has a rutile type crystal structure. In addition, the ruthenium oxide powder preferably satisfies Lc/La of 0.6913 or greater, when an a-axis lattice constant and a c-axis lattice constant as measured by X-ray diffraction are determined as La and Lc, respectively, and preferably has a crystallite size of 10 nm or greater and 80 nm or less.

### (1-2) Glass Powder

As the glass powder, a glass powder, which has been used for a thick film resistor paste, can be used.

The glass powder includes, for example, SiO₂, B₂O₃, and RO (R is at least one alkaline earth metal element selected from the group consisting of Ca, Sr, and Ba). When a total mass of SiO₂, B₂O₃, and RO is determined as 100 parts by mass, SiO₂ is preferably included in the amount of 18 parts by mass or greater and 50 parts by mass or less, B₂O₃ is preferably included in the amount of 10 parts by mass or greater and 30 parts by mass or less, and RO is preferably included in the amount of 35 parts by mass or greater and 70 parts by mass or less. Since the above glass powder is used, a temperature coefficient of resistance of a thick film resistor to be obtained can be particularly readily brought close to 0.

### (1-3) Blending Ratio Between Ruthenium Oxide Powder and Glass Powder

Since ratios of the ruthenium oxide powder and the glass powder included in the thick film resistor paste can be varied depending on a desired resistance value or the like, a mass ratio between the ruthenium oxide powder and the glass powder included in the thick film resistor paste of the present embodiment is not particularly limited.

However, in the thick film resistor paste of the present embodiment, a ratio of a mass of the ruthenium oxide powder to a mass of the glass powder is preferably in the range of 60:40 to 5:95. Specifically, when a total mass of the ruthenium oxide powder and the glass powder is determined as 100%, a mass ratio of the ruthenium oxide powder based on the percentage is preferably 5% or greater and 60% or less.

### (1-4) Organic Vehicle

The organic vehicle included in the thick film resistor paste of the present disclosure is not particularly limited, and various organic vehicles can be used as the organic vehicle.

As the organic vehicle, for example, a solution in which a resin, such as ethyl cellulose, acrylic acid ester, methacrylic acid ester, rosin, maleic acid ester, or the like, is dissolved in a solvent, such as terpineol, butyl carbitol, butyl carbitol acetate, or the like, can be suitably used.

A dispersant, a plasticizer, or the like may be added to the organic vehicle, as necessary.

### (1-5) Additives

The thick film resistor paste of the present embodiment may include various additives described in the thick film resistor composition in addition to the dispersing agent and the plasticizer, which are described in association with the above organic vehicle.

### (2) Dispersing Method

As described above, the ruthenium oxide powder and the glass powder, and the optionally added additives are preferably mixed and dispersed in the organic vehicle.

A dispersion method for the ruthenium oxide powder, the glass powder, the additives, and the like is not particularly limited. Dispersion is typically performed using, for example, a three-roll mill, a bead mill, a planetary mill, or the like, which is configured to disperse fine particles. A blending ratio of the organic vehicle may be appropriately adjusted according to a printing or coating method of the thick film resistor paste, and is therefore not particularly limited. When a total amount of the ruthenium oxide powder, the glass powder, and the additives is determined as 100 parts by mass, for example, the thick film resistor paste preferably includes the organic vehicle in the amount of 20 parts by mass or greater and 200 parts by mass or less.

### [Production Method for Thick Film Resistor]

Next, a production method for the thick film resistor of the present embodiment will be described. Since the above-described thick film resistor can be produced by the production method for the thick film resistor of the present embodiment, redundant description will be partially omitted.

The above-described thick film resistor can be produced, for example, by using the above-described thick film resistor composition or thick film resistor paste.

Therefore, the above-described thick film resistor can include ruthenium oxide derived from the above-described ruthenium oxide powder, and glass derived from the above-described glass powder.

The production method for the thick film resistor of the present embodiment is not particularly limited. For example, the thick film resistor can be formed by firing the above-described thick film resistor composition on a ceramic substrate. As described above, the thick film resistor can be also formed by applying the above-described thick film resistor paste on a ceramic substrate, followed by drying and firing the paste.

The production method for the thick film resistor of the present disclosure can be performed, for example, by using the above-described thick film resistor paste, and can include the following printing step, drying step, and firing step.

In the printing step, the above-described thick film resistor paste can be printed, for example, between a pair of electrodes formed by a thick film technology available in the related art.

In the drying step, drying is performed by heating the thick film resistor paste so that the solvent, such as the organic vehicle or the like, included in the thick film resistor paste constituting the printed film printed by the printing step can be evaporated.

In the firing step, the printed film dried in the drying step can be fired under temperature conditions in which the peak temperature becomes 800° C. or higher and 900° C. or lower.

The thick film resistor of the present embodiment can be produced by performing the firing step.

A resistance value of the obtained thick film resistor can be adjusted by forming a glass coating on a surface of the thick film resistor according to thick film technology known in the related art, and performing laser trimming known in the related art.

### EXAMPLES

Hereinafter, specific examples and comparative examples will be described, but the below examples shall not be construed as limiting the scope of the present invention.

### [Evaluation Methods]

### (1) Evaluation Method of Ruthenium Oxide Powder and Glass Powder Serving as Raw Materials

### (1-1) Lattice Constants and Crystallite Size

The lattice constants and crystallite size of the ruthenium oxide powder were determined by the Rietveld refinement of X-ray diffraction.

Moreover, Lc/La was calculated by determining the determined a-axis lattice constant of the ruthenium oxide powder as La, and the determined c-axis lattice constant of the ruthenium oxide powder as Lc.

### (1-2) Specific Surface Area Diameter

The specific surface area diameter of the ruthenium oxide powder was calculated from the specific surface area and density of the ruthenium oxide powder. The specific surface area was measured by a single-point BET method, which allowed the simple measurement of a specific surface area. When the specific surface area diameter is determined as D (nm), the density is determined as ρ (g/cm³), the specific surface area is determined as S (m²/g), and the included particles are determined as spheres, the relational expression represented by the following equation (A) is established. The specific surface area diameter calculated by D was determined as the specific surface area diameter of the ruthenium oxide powder.

$$D ( nm ) = 6 \times {10}^{3} / ( ρ \cdot S ) \qquad ( A )$$

When the specific surface area diameter was calculated, the density p of the ruthenium oxide was set to 7.05 g/cm³.

In addition, a ratio between the crystallite size and the specific surface area diameter was calculated.

### (1-3) Softening Point of Glass Powder

The softening point of the glass powder was determined as a temperature of a peak on a differential thermal curve obtained by heating the glass powder at a heating rate of 10° C./min in the ambient atmosphere according to differential thermal analysis (TG-DTA), where the peak was present on a high temperature side relative to the lowest temperature at which the differential thermal curve started to decrease, and was a subsequent peak at which the differential thermal curve started to decrease.

### (2) Evaluation Method of Thick Film Resistor

### (2-1) Film Thickness

The film thickness of the thick film resistor was determined as follows. First, five thick film resistors produced in each of Examples and Comparative Examples under the same conditions were subjected to the measurement of the film thickness using a stylus thickness roughness tester. The arithmetic mean of the obtained film thickness values of the five thick film resistors of each of Examples and Comparative Examples was calculated as a film thickness (fired film thickness) of the thick film resistor of each of Examples and Comparative Examples.

### (2-2) Sheet Resistance and CVR (Coefficient of Variation Ratio of Sheet Resistance)

The sheet resistance was determined by calculating the arithmetic mean of the values of the sheet resistance measured on twenty-five thick film resistors of each of Examples and Comparative Examples under the same conditions.

The sheet resistance of each thick film resistor was measured by a digital multimeter (No. 2001, produced by KEITHLEY).

The coefficient of variation ratio (CVR) of the sheet resistance was determined by dividing the standard deviation of the sheet resistance values of the twenty-five thick film resistors of each of Examples and Comparative Examples produced under the same conditions with the arithmetic mean of the sheet resistance values. CVR indicates a variation in a resistance value. The smaller the value of CVR is, the smaller the variation in the resistance value is. Therefore, CVR is, for example, preferably 5% or less.

### (2-3) Temperature Coefficient of Resistance

Five thick film resistors of each of Examples and Comparative Examples produced under the same conditions were subjected to the measurement of the resistance value with retention of each of temperatures −55° C., 25° C., and 125° C. for 15 minutes, and the resistance value measured at the temperatures −55° C., 25° C., and 125° C. were determined as R₋₅₅, R₂₅, and R₁₂₅, respectively.

A cold temperature coefficient of resistance (COLD-TCR) and a hot temperature coefficient of resistance (HOT-TCR) of each of the thick film resistors were calculated by the following equations (B) and (C), respectively, and the arithmetic mean of the values determined from the five thick film resistors was calculated. The cold temperature coefficient of resistance is presented in the column of “C-TCR” in Tables 3 and 4, and the hot temperature coefficient of resistance is presented in the column of “H-TCR” in Tables 3 and 4.

As the temperature coefficient of resistance, both COLD-TCR and HOT-TCR are preferably closer to 0. For both temperature coefficients of resistance, a standard for a resistor of high precision is −50 ppm/° C. or greater and +50 ppm/° C. or less.

$$COLD - TCR ( ppm / ° C . ) = ( {R}_{- 55} - {R}_{25} ) / {R}_{25} / ( - 80 ) \times {10}^{6} \qquad ( B )$$

$$HOT - TCR ( ppm / ° C . ) = ( {R}_{125} - {R}_{25} ) / {R}_{25} / ( 100 ) \times {10}^{6} \qquad ( C )$$

In each of Examples and Comparative Examples, the difference between COLD-TCR and HOT-TCR was calculated. The result is presented in the column “H/C difference” of Tables 3 and 4.

### (2-4) Short Term Overload (STOL) Test

A change rate of resistance value in a short term overload (STOL) test was determined by applying voltage corresponding to 0.25 W, which was 2.5 times an overload voltage (400 V when the overload voltage exceeded 400 V) to the thick film resistor produced in each of Examples and Comparative Examples for 5 seconds, and calculating a change rate in the resistance value after the application of the voltage. The resistance value was measured in the same manner as the above-described measurement method of the sheet resistance. In the evaluation of STOL, measurement and calculation were performed on ten thick film resistors of each of Examples and Comparative Examples. The change rate of the resistance value in the short term overload (STOL) test is preferably within +18, and more preferably within +0.5%.

### (2-5) Current Noise

Current noise of five thick film resistors of each of Examples and Comparative Examples produced under the same conditions was measured, and the arithmetic mean of the measured values was calculated.

The current noise was measured by applying voltage corresponding to 1/10 W using a noise analyzer (model: 315c, produced by Quan-Tech). The current noise of the thick film resistor correlates with overload characteristics and reliability. The lower the value is, the better the electrical characteristics of the resistor are.

(2-6) Lattice Constants and Crystallite Size of Ruthenium Oxide Included in Dried Film and in Thick Film resistor

A ruthenium oxide powder, a glass powder, and an additive powder (MnO₂, TiO₂, CuO, and SiO₂) were blended at the ratio presented in Tables 3 and 4, thereby forming a thick film resistor composition. A below-described thick film resistor paste was prepared using the thick film resistor composition, and the thick film resistor paste in the amount of 96 percent by mass was printed on an alumina ceramic substrate (alumina substrate) by screen printing, thereby obtaining a printed film. The printed film was subjected to a below-described drying step and firing step, thereby obtaining a dried film and a fired product, respectively. In the drying step, the printed film was dried at a peak temperature of 150° C. for a peak retention time of 5 minutes, thereby obtaining a dried film. In the firing step, the dried film was fired at a peak temperature of 850° C. for a peak retention time of 9 minutes, thereby obtaining a fired product (fired film). X-ray diffraction analysis was performed on the obtained dried film and fired product, and lattice constants and crystallite size of ruthenium included in the dried film and in the fired product were determined by the Rietveld refinement of X-ray diffraction. The lattice constants and crystallite size of ruthenium oxide in the dried film are presented in the column of “Properties of ruthenium oxide in dried film” in Tables 3 and 4. In addition, the lattice constants and crystallite of ruthenium oxide in the thick film resistor are presented in the column of “Properties of ruthenium oxide in thick film resistor” in Tables 3 and 4.

The current noise is presented simply as noise in Tables 3 and 4.

### Examples 1 to 10

### (1) Thick Film Resistor Composition

In Examples 1 to 10, a ruthenium oxide powder, a glass powder, and an additive powder (MnO₂, TiO₂, CuO, and SiO₂) were blended at a ratio presented in Table 3, thereby forming a thick film resistor composition.

Note that in Table 3, “RuO₂” represents a blending ratio of the ruthenium oxide powder, and “Glass” represents a blending ratio of the glass powder. Moreover, “MnO₂,” “TiO₂,” “CuO,” and “SiO₂” represents a blending ratio of a corresponding component of the additives.

In Example 1, for example, the ruthenium oxide powder of A in Table 1 was used, as presented in the column “Type of ruthenium oxide powder” in Table 3. In Example 1, moreover, the glass powder of a in Table 2 was used, as presented in the column “Type of glass powder” in Table 3.

In Example 1, therefore, 50 parts by mass of the ruthenium oxide powder of A, 50 parts by mass of the glass powder of a, and as the additives, 1.5 parts of MnO₂, and 1 part by mass of CuO were mixed to prepare a thick film resistor composition.

### (Ruthenium Oxide Powder)

A specific surface area diameter, crystallite size, and lattice constants of each of the ruthenium oxide powders A to G used in corresponding Example are presented in Table 1. The crystallite size and lattice constants of the ruthenium oxide powder used in each Example are also presented in the column of “Properties of ruthenium oxide powder as raw material” in Table 3. In Table 1, “c-axis lattice constant/a-axis lattice constant” corresponds to Lc/La, which is a ratio of the c-axis lattice constant Lc to the a-axis lattice constant.

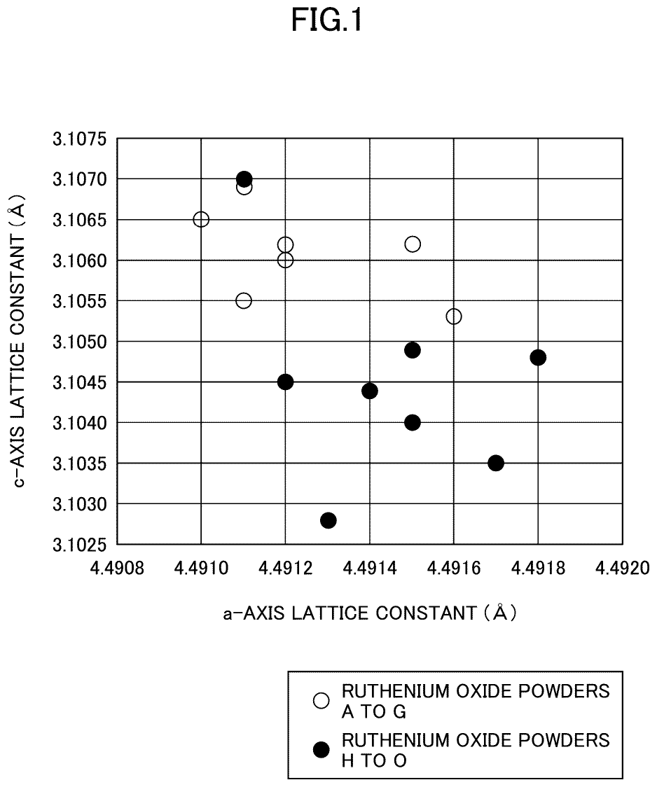

Note that the relationship between the a-axis lattice constant and the c-axis lattice constant of the ruthenium oxide powder used in each of Examples and Comparative Examples is depicted in FIG. 1. As depicted in FIG. 1, it was confirmed that there was no clear correlation between the a-axis lattice constant and the c-axis lattice constant.

### (Glass Powder)

Moreover, a composition of the glass powder used in each of Examples and Comparative Examples is presented in Table 2.

In Examples and Comparative Examples, lead-free glass powders were used as the glass powder a to the glass powder c in view of prevention of environmental pollution. However, lead-containing glass, which has been used in the related art, may also be used.

Further, each of the glass powders a to c was pulverized so that a median diameter of a particle size distribution, which was measured by a laser diffraction particle size distribution analyzer, was to be 1.3 μm or greater and 1.5 μm or less. Specifically, all of the glass powders a to c had a 50% volume cumulative particle size of 1.3 μm or greater and 1.5 μm or less.

### (Additives)

As the additives, at least one selected from the group consisting of MnO₂, TiO₂, CuO, and SiO₂ was used as described above.

As the particle size of the additives, the particle size of MnO₂ was 0.5 μm, the particle size of TiO₂ was 0.3 μm, the particle size of CuO was 0.5 μm, and the particle size of SiO₂ was 15 nm.

Each of the above particle sizes of MnO₂, TiO₂, and CuO is a median diameter of a particle size distribution measured by a laser diffraction particle size analyzer similar to the case of the glass powder. Specifically, each of the above particle sizes is a 50% volume cumulative particle size.

The above particle size of SiO₂ was a specific surface area diameter, and the specific surface area was measured by the BET method. Specifically, the specific surface area of SiO₂ was calculated in the same manner as the specific surface area diameter of the above-described ruthenium oxide powder. Note that the density p of SiO₂ was 2.2 g/cm³.

### (2) Thick Film Resistor Paste

In the thick film resistor composition of each of Examples, 43 parts by mass of an organic vehicle was added relative to 100 parts by mass of a total amount of the ruthenium oxide powder, the glass powder, and the additives, and the resulting mixture was dispersed using a three-roll mill, thereby producing a thick film resistor paste.

Note that a mixture in which 5 percent by mass or greater and 25 percent by mass or less of ethyl cellulose and 75 percent by mass or greater and 95 percent by mass or less of terpineol were mixed was used as the organic vehicle. The ratio of each of the components in the organic vehicle was adjusted within the above range so that the viscosities of the thick film resistor pastes according to Examples 1 to 10 had substantially the same value.

### (3) Thick Film Resistor

The thick film resistor paste produced in each of Examples was printed on an alumina substrate (aluminum oxide substrate) in advance to form a printed film (printing step).

The printed film obtained in the printing step was dried in a manner such that a peak temperature was 150° C., and a retention time at the peak temperature was 5 minutes (drying step).

Subsequently, the dried film obtained in the drying step was fired in a manner such that a peak temperature was 850° C. and a retention time at the peak temperature was 9 minutes, thereby forming a thick film resistor (firing step).

A sample for measurement of the lattice constants and crystallite size of ruthenium oxide was prepared so that a resistor was formed in a square pattern having a size of 20.0 mm×20.0 mm.

A sample for measurement of the film thickness, the sheet resistance, CVR, the temperature coefficient of resistance, the short term overload (STOL) test, and the current noise was formed using the thick film resistor paste that was provided between a pair of electrodes. The pair of electrodes were formed in advance by firing an electrode material on an alumina substrate (aluminum oxide substrate). For the pair of electrodes, a thick film Ag/Pd including 1 percent by mass of Pd and 99 percent by mass of Ag was used. In addition, the sample of the thick film resistor for measuring sheet resistance or the like was formed between the pair of electrodes to have a resistor width of 1.0 mm and a resistor length (gap between electrodes) of 1.0 mm.

The above-described evaluations were performed on the obtained thick film resistor. The evaluation results are presented in Table 3.

It was confirmed that the ruthenium oxide included in the thickness film resistors produced in Examples 1 to 10 had a rutile type crystal structure.

TABLE 1

| | | | | | | Crystallite | c-axis |
|---|---|---|---|---|---|---|---|
| | | Specific | | | | size/ | lattice |
| | Specific | surface | | a-Axis | c-Axis | specific | constant/ |
| Ruthenium | surface | area | Crystallite | lattice | lattice | surface | a-axis |
| oxide | area | diameter | size | constant | constant | area | lattice |
| powder | (m²/g) | (nm) | (nm) | (Å) | (Å) | diameter | constant |
| A | 59.2 | 14.4 | 12.1 | 4.4916 | 3.1053 | 0.8417 | 0.69136 |
| B | 40.3 | 21.1 | 21.3 | 4.4915 | 3.1062 | 1.0086 | 0.69157 |
| C | 31.7 | 26.8 | 25.8 | 4.4911 | 3.1055 | 0.9610 | 0.69148 |
| D | 24.8 | 34.3 | 34 | 4.4912 | 3.1062 | 0.9908 | 0.69162 |
| E | 18.4 | 46.3 | 46.1 | 4.4912 | 3.106 | 0.9967 | 0.69157 |
| F | 15 | 56.7 | 56.3 | 4.491 | 3.1065 | 0.9923 | 0.69172 |
| G | 11.6 | 73.4 | 76.7 | 4.4911 | 3.1069 | 1.0454 | 0.69179 |
| H | 86.5 | 9.8 | 9.8 | 4.4913 | 3.1028 | 0.9960 | 0.69085 |
| I | 56.7 | 15.0 | 12.6 | 4.4917 | 3.1035 | 0.8394 | 0.69094 |
| J | 35.9 | 23.7 | 22.2 | 4.4915 | 3.104 | 0.9365 | 0.69108 |
| K | 31.7 | 26.8 | 25.7 | 4.4914 | 3.1044 | 0.9573 | 0.69119 |
| L | 22.6 | 37.7 | 34.9 | 4.4912 | 3.1045 | 0.9268 | 0.69124 |
| M | 15.9 | 53.5 | 55.3 | 4.4918 | 3.1048 | 1.0331 | 0.69122 |
| N | 11.9 | 71.5 | 78.3 | 4.4915 | 3.1049 | 1.0948 | 0.69128 |
| O | 17.4 | 48.9 | 86.2 | 4.4911 | 3.107 | 1.7624 | 0.69181 |

TABLE 2

| | | | | | | | | | SiO₂/ | B₂O₃/ | RO/ | Soften- |
|---|---|---|---|---|---|---|---|---|---|---|---|---|
| | | | | | | | | | (SiO₂ + | (SiO₂ + | (SiO₂ + | ing |
| Glass | SiO₂ | B₂O₃ | CaO | SrO | BaO | Al₂O₃ | ZnO | Total | B₂O₃ + | B₂O₃ + | B₂O₃ + | point |
| powder | (mass %) | (mass %) | (mass %) | (mass %) | (mass %) | (mass %) | (mass %) | (mass %) | RO) | RO) | RO) | (° C.) |
| a | 38 | 16 | 10 | — | 20 | 5 | 11 | 100 | 45.2 | 19.0 | 35.7 | 720 |
| b | 24 | 21 | 20 | 3 | 12 | 4 | 16 | 100 | 30.0 | 26.3 | 43.8 | 710 |
| c | 17 | 11 | 14 | — | 45 | 3 | 10 | 100 | 19.5 | 12.6 | 67.8 | 680 |

TABLE 3

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Type of ruthenium | | A | B | B | C | D | D | E | F | F | G |
| oxide powder | | | | | | | | | | | |
| Type of glass powder | | a | a | a | b | b | b | c | c | c | c |
| Compo- | RuO₂ | 50 | 58 | 41 | 46 | 34 | 16 | 14 | 18 | 6 | 12 |
| sition | (mass parts) | | | | | | | | | | |
| of raw | Glass | 50 | 42 | 59 | 54 | 66 | 84 | 86 | 82 | 94 | 88 |
| material | (mass parts) | | | | | | | | | | |
| powder | MnO₂ | 1.5 | 1.5 | 1 | 0.8 | — | — | — | — | — | — |
| | (mass parts) | | | | | | | | | | |
| | TiO₂ | — | — | 0.5 | 0.3 | 0.8 | 0.2 | 0.2 | 0.2 | 0.1 | 0.2 |
| | (mass parts) | | | | | | | | | | |
| | CuO | 1 | 1 | 1 | 0.5 | — | — | 0.5 | 1 | 0.8 | 1 |
| | (mass parts) | | | | | | | | | | |
| | SiO₂ | — | — | — | — | — | — | 5 | 5 | — | 5 |
| | (mass parts) | | | | | | | | | | |
| | Total | 102.5 | 102.5 | 102.5 | 101.6 | 100.8 | 100.2 | 105.7 | 106.2 | 100.9 | 106.2 |
| Properties | Fired film | 7.5 | 8 | 7.8 | 8.2 | 6.8 | 7.7 | 8.1 | 8 | 7.5 | 8.1 |
| of thick | thickness (μm) | | | | | | | | | | |
| film | Sheet | 41 | 48 | 102 | 93 | 1.06K | 9.73K | 97.9K | 991K | 10.4M | 0.99M |
| resistor | resistance (Ω) | | | | | | | | | | |
| | CVR (%) | 1.9 | 2.2 | 2 | 2.3 | 2.4 | 2.5 | 2.3 | 3.1 | 3 | 3.3 |
| | C-TCR | −29 | −4 | −5 | −2 | −6 | −13 | −11 | −20 | −26 | −22 |
| | (ppm/° C.) | | | | | | | | | | |
| | H-TCR | 27 | 12 | 15 | 17 | 8 | 3 | 12 | 4 | 3 | 6 |
| | (ppm/° C.) | | | | | | | | | | |
| | H/C difference | 56 | 16 | 20 | 19 | 14 | 16 | 23 | 24 | 29 | 28 |
| | (ppm/° C.) | | | | | | | | | | |
| | STOL (%) | 0.005 | 0.011 | 0.002 | 0.001 | −0.001 | −0.010 | −0.038 | −0.034 | −0.102 | −0.360 |
| | Noise (dB) | −41 | −40 | −38 | −36 | −19 | −19 | −10 | −5 | 5 | 0 |
| Properties | Crystallite | 12.1 | 21.3 | 21.3 | 25.8 | 34 | 34 | 46.1 | 56.3 | 56.3 | 76.7 |
| of | size (nm) | | | | | | | | | | |
| ruthenium | a-axis lattice | 4.4916 | 4.4915 | 4.4915 | 4.4911 | 4.4912 | 4.4912 | 4.4912 | 4.491 | 4.491 | 4.4911 |
| oxide | constant La (Å) | | | | | | | | | | |
| powder | c-axis lattice | 3.1053 | 3.1062 | 3.1062 | 3.1055 | 3.1062 | 3.1062 | 3.106 | 3.1065 | 3.1065 | 3.1069 |
| of raw | constant Lc (Å) | | | | | | | | | | |
| material | Lc/La | 0.69136 | 0.69157 | 0.69157 | 0.69148 | 0.69162 | 0.69162 | 0.69157 | 0.69172 | 0.69172 | 0.69179 |
| Properties | Crystallite | 2.5 | 21.1 | 21.9 | 25.5 | 34.3 | 34.2 | 46.1 | 56 | 56.4 | 76.3 |
| of | size (nm) | | | | | | | | | | |
| ruthenium | a-axis lattice | 4.491 | 4.4908 | 4.491 | 4.4903 | 4.4908 | 4.4905 | 4.4912 | 4.491 | 4.491 | 4.4912 |
| oxide | constant La (Å) | | | | | | | | | | |
| in dried | c-axis lattice | 3.1049 | 3.1063 | 3.1059 | 3.1066 | 3.1063 | 3.1066 | 3.10656 | 3.1063 | 3.1066 | 3.10663 |
| film | constant Lc (Å) | | | | | | | | | | |
| | Lc/La | 0.69136 | 0.69170 | 0.69158 | 0.69185 | 0.69170 | 0.69182 | 0.69170 | 0.69167 | 0.69174 | 0.69171 |
| Properties | Crystallite | 13.4 | 23.8 | 24 | 27.4 | 35 | 35.6 | 47.5 | 58.2 | 58.1 | 79.4 |
| of | size (nm) | | | | | | | | | | |
| ruthenium | a-axis lattice | 4.4972 | 4.4962 | 4.4953 | 4.4954 | 4.4945 | 4.4949 | 4.4958 | 4.4934 | 4.4946 | 4.4956 |
| oxide in | constant La (Å) | | | | | | | | | | |
| thick | c-axis lattice | 3.0968 | 3.0979 | 3.09727 | 3.09768 | 3.0977 | 3.0977 | 3.0999 | 3.0987 | 3.0982 | 3.1006 |
| film | constant Lc (Å) | | | | | | | | | | |
| resistor | Lc/La | 0.68861 | 0.68900 | 0.68900 | 0.68908 | 0.68922 | 0.68916 | 0.68951 | 0.68961 | 0.68932 | 0.68970 |

### Comparative Examples 1 to 8

A thick film resistor composition and a thick film resistor paste were produced in the same manner as in Examples 1 to 10, except that a ruthenium oxide powder, a glass powder, and additives presented in Table 4 were used, and amounts of the above components were changed as presented in Table 4. The evaluation results are presented in Table 4.

TABLE 4

| | | Comp. | Comp. | Comp. | Comp. | Comp. | Comp. | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Type of ruthenium | | H | I | J | K | L | M | N | O |
| oxide powder | | | | | | | | | |
| Type of glass powder | | a | a | a | b | b | c | c | c |
| Compo- | RuO₂ | 48 | 50 | 42 | 46 | 35 | 18 | 12 | 9 |
| sition | (mass parts) | | | | | | | | |
| of raw | Glass | 52 | 50 | 58 | 54 | 65 | 82 | 88 | 91 |
| material | (mass parts) | | | | | | | | |
| powder | MnO₂ | 1.2 | 1.3 | 0.9 | 0.6 | — | — | — | — |
| | (mass parts) | | | | | | | | |
| | TiO₂ | — | — | 0.5 | 0.3 | 0.6 | — | — | — |
| | (mass parts) | | | | | | | | |
| | CuO | 1 | 1 | 1 | 0.5 | — | 1 | 1 | 1 |
| | (mass parts) | | | | | | | | |
| | SiO₂ | — | — | — | — | — | 5 | 5 | 5 |
| | (mass parts) | | | | | | | | |
| | Total | 102.2 | 102.3 | 102.4 | 101.4 | 100.6 | 106 | 106 | 106 |
| Properties | Fired film | 8 | 8.1 | 7.8 | 7.7 | 8.2 | 7.7 | 8 | 8.1 |
| of thick | thickness (μm) | | | | | | | | |
| film | Sheet | 38 | 40 | 103 | 95 | 1.05K | 1.01M | 0.99M | 9.70M |
| resistor | resistance (Ω) | | | | | | | | |
| | CVR (%) | 3.3 | 2.8 | 2.8 | 2.2 | 2.3 | 3.7 | 5.7 | 8.2 |
| | C-TCR | −89 | −60 | −52 | −62 | −52 | −253 | −269 | −28 |
| | (ppm/° C.) | | | | | | | | |
| | H-TVR | 29 | 38 | 33 | 6 | 30 | −135 | −145 | −2 |
| | (ppm/° C.) | | | | | | | | |
| | H/C difference | 118 | 98 | 85 | 68 | 82 | 118 | 124 | 26 |
| | (ppm/° C.) | | | | | | | | |
| | STOL (%) | 0.013 | 0.005 | 0.003 | 0.002 | −0.012 | −0.612 | −1.032 | −1.56 |
| | Noise (dB) | −35 | −39 | −32 | −31 | −15 | 5 | 8 | >15 |
| Properties | Crystallite | 9.8 | 12.6 | 22.2 | 25.7 | 34.9 | 55.3 | 78.3 | 86.2 |
| of | size (nm) | | | | | | | | |
| ruthenium | a-axis lattice | 4.4913 | 4.4917 | 4.4915 | 4.4914 | 4.4912 | 4.4918 | 4.4915 | 4.4911 |
| oxide | constant La (Å) | | | | | | | | |
| powder | c-axis lattice | 3.1028 | 3.1035 | 3.104 | 3.1044 | 3.1045 | 3.1048 | 3.1049 | 3.107 |
| of raw | constant Lc (Å) | | | | | | | | |
| material | Lc/La | 0.69085 | 0.69094 | 0.69108 | 0.69119 | 0.69124 | 0.69122 | 0.69128 | 0.69181 |
| Properties | Crystallite | 9.9 | 12.6 | 22.2 | 25.7 | 34.9 | 55.3 | 78.3 | 85.5 |
| of | size (nm) | | | | | | | | |
| ruthenium | a-axis lattice | 4.491 | 4.492 | 4.4913 | 4.4914 | 4.4911 | 4.4917 | 4.4917 | 4.4914 |
| oxide | constant La (Å) | | | | | | | | |
| in dried | c-axis lattice | 3.1025 | 3.1035 | 3.1039 | 3.1042 | 3.1041 | 3.1051 | 3.1049 | 3.1067 |
| film | constant Lc (Å) | | | | | | | | |
| | Lc/La | 0.69083 | 0.69089 | 0.69109 | 0.69114 | 0.69117 | 0.69130 | 0.69125 | 0.69170 |
| Properties | Crystallite | 14.4 | 15.9 | 23.8 | 27.5 | 36.3 | 57.1 | 81 | 94.1 |
| of | size (nm) | | | | | | | | |
| ruthenium | a-axis lattice | 4.4996 | 4.4992 | 4.4945 | 4.4934 | 4.4922 | 4.4921 | 4.4918 | 4.4949 |
| oxide in | constant La (Å) | | | | | | | | |
| thick | c-axis lattice | 3.0949 | 3.0963 | 3.0928 | 3.0925 | 3.0916 | 3.0924 | 3.0917 | 3.0998 |
| film | constant Lc (Å) | | | | | | | | |
| resistor | Lc/La | 0.68782 | 0.68819 | 0.68813 | 0.68823 | 0.68822 | 0.68841 | 0.68830 | 0.68963 |

According to the results presented in Tables 3 and 4, the lattice constants and crystallite size of the ruthenium oxide in the dried film were substantially the same as the lattice constants and crystallite size of the ruthenium oxide powder used as a raw material of the resistor paste. This suggests that the lattice constants and crystallite size were hardly changed in the step of dispersing or kneading the ruthenium oxide powder and the glass powder in the organic vehicle.

However, the lattice constants and crystallite size of ruthenium oxide measured on the thick film resistor formed by firing the dried resistor paste were changed from the lattice constants and crystallite size of ruthenium oxide measured in the state of the dried resistor paste.

Specifically, the a-axis lattice constant La and crystallite size of the ruthenium oxide increased, and the c-axis lattice constant Lc decreased. Therefore, Lc/La decreases and the crystallite size increases, as the resistor paste is fired.

In the case where Lc/La of the ruthenium oxide in the thick film resistor formed by printing, drying, and firing the resistor paste was 0.6885 or greater, both COLD-TCR and HOT-TCR were close to 0. Moreover, in the case where the crystallite size of the ruthenium oxide of the thick film resistor was 10 nm or greater and 80 nm or less (100 Å or greater and 800 Å or less), excellent electrical characteristics were obtained.

It was confirmed that the thick film resistors of Examples 1 to 10 had COLD-TCR and HOT-TCR, which were both close to 0, i.e., within +30 ppm/° C., and had a small difference between H and C, i.e., 70 ppm/° C. or less, thereby realizing a highly precise temperature coefficient of resistance.

Moreover, it was confirmed that the thick film resistors of Examples 1 to 10 had the change rate of the resistance value in the short term overload (STOL) test, which was within ±0.5%, had sufficiently small current noise, and had excellent characteristics.

As described above, in each of Examples 1 to 10, the thick film resistor (fired product), in which the ruthenium oxide had a rutile type crystal structure, satisfied Lc/La of 0.6885 or greater, where Lc/La was a ratio of the c-axis lattice constant Lc to the a-axis lattice constant, and had a crystallite size of 10 nm or greater and 80 nm or less, was obtained. In addition, it was confirmed that the thick film resistors of Examples 1 to 10 could bring both the cold temperature coefficient of resistance and the hot temperature coefficient of resistance close to 0, and could reduce the difference between the cold temperature coefficient of resistance and the hot temperature coefficient of resistance.

Further, it was confirmed that the change rate in the resistance value in the short term overload (STOL) test was small, i.e., within ±0.5%, because the crystallite size of the ruthenium oxide was 10 nm or greater and 80 nm or less.

Conversely, the thick film resistors (fired products) of Comparative Examples 1 to 7 had Lc/La of less than 0.6885. Accordingly, it was confirmed that the thick film resistors obtained in the above Comparative Examples tended to have a large difference between the cold temperature coefficient of resistance and the hot temperature coefficient of resistance, and both could not fall within the range of +30 ppm/° C. Further, it was confirmed that the temperature coefficient of resistance was significantly in minus in Comparative Examples 6 and 7, although TiO₂ and MnO₂, which would shift the temperature coefficient of resistance to the minus side, were not added.

Further, in Comparative Example 8, Lc/La was 0.68963, and both COLD-TCR and HOT-TCR were within ±30 ppm/° C., but the crystallite size was as large as 94.1 nm, and the coefficient of variation ratio (CVR) indicating a variation of the resistance value was greater than 5%. Further, the change rate of the resistance value was greater than ±0.5% in the short term overload (STOL) test.

It was confirmed from the results of Examples and Comparative Examples above that a temperature coefficient of resistance could be easily adjusted to within ±30 ppm/° C., which was difficult to achieve in the related art, by controlling lattice constants and a crystallite size of ruthenium oxide in a thick film resistor that included the ruthenium oxide as a conductive phase. In addition, it was confirmed that the thick film resistor, in which the lattice constants and crystallite size of the ruthenium oxide were controlled, could attain a temperature coefficient of resistance with high precision.

Although the thick film resistor has been described through the embodiments, examples, and the like above, the present invention is not limited to the above embodiments, examples, and the like. Various modifications and changes can be made within the scope of the gist of the present invention as defined in the claims.

This application claims priority under Japanese Patent Application No. 2023-075114 filed Apr. 28, 2023, and the entire contents of Japanese Patent Application No. 2023-075114 are incorporated herein by reference.

1. A thick film resistor comprising:
ruthenium oxide; and
glass,
wherein the ruthenium oxide has a rutile type crystal structure,
the ruthenium oxide satisfies a ratio Lc/La set to 0.6885 or greater, when an a-axis lattice constant and a c-axis lattice constant of the ruthenium oxide as measured by X-ray diffraction are determined as La and Lc, respectively, and
the ruthenium oxide has a crystallite size of 10 nm or greater and 80 nm or less.

2. The thick film resistor according to claim 1,
wherein, when a total mass of the ruthenium oxide and the glass is determined as 100%, a mass ratio of the ruthenium oxide is 5% or greater and 60% or less.

3. The thick film resistor according to claim 1,
wherein the glass includes SiO₂, B₂O₃, and RO (R is at least one alkaline earth metal element selected from the group consisting of Ca, Sr, and Ba), and
when a total mass of SiO₂, B₂O₃, and RO is determined as 100 parts by mass, SiO₂ is included in an amount of 18 parts by mass or greater and 50 parts by mass or less, B₂O₃ is included in an amount of 10 parts by mass or greater and 30 parts by mass or less, and RO is included in an amount of 35 parts by mass or greater and 70 parts by mass or less.
